(19) United States
(12) Patent Application Publication
(10) Pub. No.: US 2017/0249229 A1
(43) Pub. Date: Aug. 31, 2017

(54) QUERY A HARDWARE COMPONENT FOR AN ANALYSIS RULE

(71) Applicant: HEWLETT PACKARD ENTERPRISE DEVELOPMENT LP, Houston, TX (US)

(72) Inventors: Andrew C. WALTON, Roseville, CA (US); Timothy F. FORELL, Palo Alto, CA (US); Zhikui WANG, Palo Alto, CA (US)

(73) Assignee: HEWLETT PACKARD ENTERPRISE DEVELOPMENT LP, Houston, TX (US)

(21) Appl. No.: 15/500,076

(22) PCT Filed: Nov. 20, 2014
(86) PCT No.: PCT/US2014/066692

§ 371 Date: Jan. 30, 2017

(51) Int. Cl. G06F 11/34; G06F 11/30; G06F 17/30

(52) U.S. Cl. CPC G06F 11/3433; G06F 17/30377; G06F 11/3024; G06F 17/30424

(57) ABSTRACT

Examples disclosed herein relate to querying a hardware component for analysis rules. For example, a processor may determine to retrieve an analysis rule associated with a hardware component within a computing system and query the hardware component for an analysis rule associated with the hardware component. The processor may analyze the computing system based on the received analysis rule associated with the first hardware component and a workload to be executed on the computing system.

### BACKGROUND

A system analysis application may analyze hardware components, such as memory module, CPU, or power supply, within a computing system as compared to particular workloads executing on the computing system. For example, the computing system performance may vary based on the speed and capacity of the components within the computing system and the specifications of the predicted workload. In one implementation, the components may be analyzed in comparison to a previous workload and its outcome, such as to determine types of changes to make to the computing system and/or to individual components within the computing system.

### BRIEF DESCRIPTION OF THE DRAWINGS

The drawings describe example embodiments. The following detailed description references the drawings, wherein:

FIG. 1 is a block diagram illustrating one example of a computing system to query a hardware component for an analysis rule.

FIG. 2 is a flow chart illustrating one example of a computing system to query a hardware component for an analysis rule.

FIG. 3 is a block diagram of one example of a computing system to store analysis rules associated with a hardware component.

FIG. 4 is a block diagram illustrating one example of a computing system to associate an analysis rule with a hardware component.

### DETAILED DESCRIPTION

A large scale computer system, such as a computer system associated with a data center or a server within a data center, may include many components, both hardware and software. Large scale computer systems may include hardware components that are field replaceable units that may be replaced or added to fix problems, upgrade capabilities, or add capacity. An analysis engine may be run on a large scale heterogeneous computer system to monitor a workload running on the system. In one implementation, the information stored based on the monitoring may be used to predict how a future workload is likely to run on the computing system, such as the likely performance time or error handling. The analysis may be performed after a workload has been executed to compare the results to the hardware component information and workload information. The analysis engine may compare the workload information to information about the behavior of the individual hardware components to determine overall analysis information related to the computing system as a whole.

In one implementation, analysis rules are determined for workloads and components separately such that the hardware component rules may be updated and analysis performed on a workload as compared to the updated hardware component rules. The computing system may determine analysis rules associated with hardware components by querying the hardware components and receiving a response from the hardware components about analysis rules to associate with them for system analysis.

Using updated analysis rules allows for the systems analysis engine to to dynamically adapt to changes in hardware performance, such as due to changes in subcomponents or software, and to changing/updated hardware components. Receiving analysis rules from the hardware components themselves allows for the computing system to update hardware component analysis rules without connecting to the Internet. In addition, updated analysis rules associated with a first hardware component may be propagated to other similar hardware components such that the analysis rules of other hardware components may be updated without receiving updates from the specific hardware components. In one implementation, the computing system determines to query the hardware component for new analysis rules, such as because analysis rules associated with the hardware component are not stored and/or the version associated with the stored analysis rules associated with the hardware component are out of date. The hardware component may respond with information about analysis rules associated with it, and the analysis rules may be stored for use by the system analysis engine.

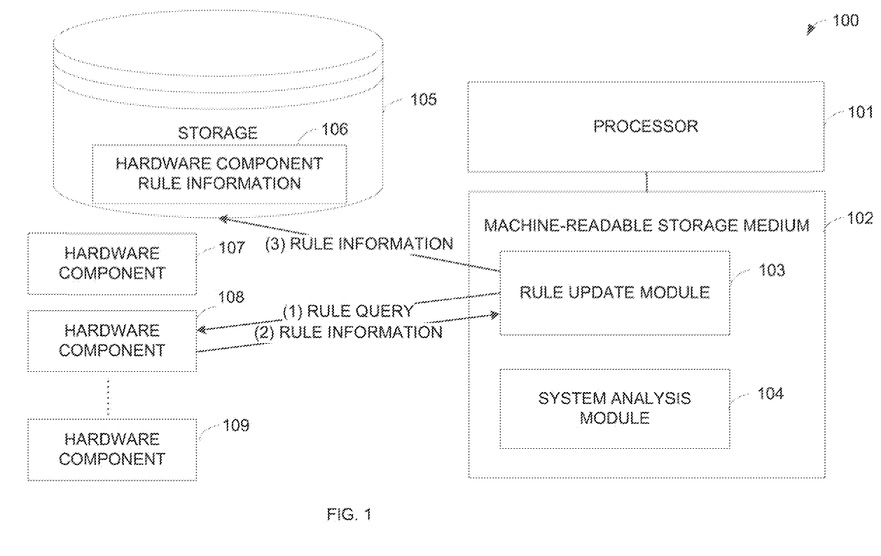

FIG. 1 is a block diagram illustrating one example of a computing system 100 to query a hardware component for an analysis rule. The computing system 100 includes a processor 101, a machine-readable storage medium 102, a storage 105 and hardware components 107-109. The computing system 100 may receive analysis rules from the hardware components 107-109 and perform system analysis based on the received information compared to workload information.

The computing system 100 may include any number of hardware components. For example, the computing system 100 includes hardware components 107-109. The hardware components 107-109 may be any suitable components related to a computing system. The hardware components 107-109 may be, for example, field replaceable units within a computing system. The hardware components 107-109 may be of the same or differing types. The hardware components 107-109 may be, for example, a solid state storage device, memory module, fan, power supply, or CPU.

The storage 105 may be any suitable storage for storing information accessible to the processor 101. The processor 101 may communicate with the storage 105 directly or via a network. The storage 105 may include information used to analyze a workload on a computing system. For example, the storage 105 may store hardware component rule information 106. The hardware component rule information 106 may be any suitable rules related to analyzing a hardware component, such as performance rules and error handling rules. The performance rules may indicate performance changes based on failures/changes in the computing system. For example, a performance rule may indicate the number of transactions that a component can handle in a given time period, and an actual performance not as expected may indicate a problem with the component or with other components linked to the component. As another example, a performance rule may indicate and/or quantify information related to determining when a hardware component is degraded and no longer viable, such as for a particular workload or type of workload. In response, a system administrator may replace the component or move the workload. The hardware component rule information 106 may include information about subcomponents and/or relationships between hardware components, and in some cases relationships between hardware components and software components. The hardware component rule information 106 may store information related to a set of hardware components. The hardware component rule information 106 may store any suitable information associated with the rules. In one implementation, the hardware component rule information 106 includes an identifier related to the hardware component, a rule, and a version or other timing information associated with the rule or a set of rules.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium.

The machine-readable medium 102 may include modules with instructions executable by the processor 101, such as the rule update module 103 and the system analysis module 104. In one implementation, the analysis rules are stored on a non-volatile memory of the hardware component, and the rule update module 103 includes instructions to read the analysis rules information stored on the non-volatile memory. The non-volatile memory may include additional information, such as configuration information. The rule update module 103 may include instructions to query the hardware components 107-109 to receive analysis rules related to the hardware components 107-109. The rule update module 103 may query the hardware components 107-109 in any suitable manner. For example, the query may be performed via network requests, 120 transactions, and accessing configuration address ranges associated with the hardware components. The rule update module 103 may receive analysis rule information in response to the query and store the analysis rules in the storage 105.

The system analysis module 104 may include instructions to analyze the computing system 100 based on the hardware component rule information 106 and information about a workload to execute on the computing system 100. In one implementation, the analysis includes information about analysis rules related to software components in the computing system 100.

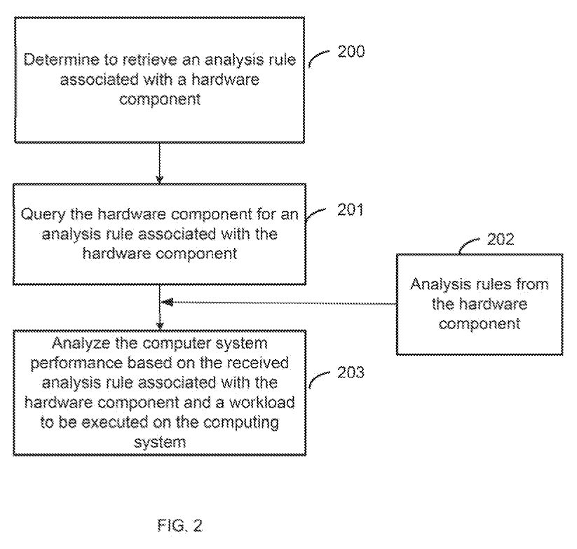

FIG. 2 is a flow chart illustrating one example of a method to query a hardware component for analysis rules. For example, in one implementation, updated analysis rules related to how a hardware component functions, such as related to performance and error handling, may not be available online because of client preferences not to connect to the Internet for rule updates. In such an instance, a processor associated with an analysis rule update engine may query the hardware component itself to receive information related to the particular component. The processor may determine that new analysis rules should be retrieved, such as based on a time since rules were last retrieved, a version associated with stored analysis rules, and/or based on a detection of a hardware component without stored analysis rules. A rules update engine may update the rules to be used by an analysis system. As an example, analysis rules may be updated due to adding, removing, or swapping hardware components. Likewise, software components may have changes in analysis rules due to operating system or application upgrading, removing, or installation. The method may be implemented, for example, by the computing system 100 of FIG. 1.

Beginning at 200, a processor determines to retrieve an analysis rule associated with a hardware component. For example, a storage may store analysis rules associated with hardware components in a computing system. In one implementation, the processor receives an information from a hardware component when it is installed within the computing system. The information may include an identifier related to the hardware component and information about the type of hardware component. In one implementation, the processor checks information related to the layout of the computing system and periodically queries the hardware components to receive identification information used to determine if the hardware component has been changed. In one implementation, the hardware component periodically broadcasts information related to its identity to the processor.

The processor may receive an identifier associated with a hardware component, such as based on a request from the processor or based on part of an initialization process associated with the hardware component. The identifier associated with the hardware component may be any suitable identifier. For example, the identifier may be a Globally Unique ID (QUID). The identifier may be a device ID and/or vendor ID. The identifiers may be used to determine if information is stored in the storage related to the hardware component. In one implementation, there are multiple rules engines, and the unique identifiers may be used to share information between the rules engines.

In one implementation, the hardware component sends a version number associated with it to the processor. The version number may include information about hardware or software associated with the hardware component. For example, a hardware component serving the same function may have the same identifier with a different version when the hardware component is upgraded. In one implementation, an identifier is unique to a particular instance of a hardware component and a version may be updated for a new firmware update or a hardware subcomponent.

In one implementation, a version or other time based information may be associated with an analysis rule, and the processor may determine whether to query the hardware component for additional rules based on the version and/or time stamp associated with the stored analysis rules.

The processor may use the identifier or other information from the hardware component to query a storage to determine the stored rules related to the hardware component. The processor may determine to query the hardware component for analysis rules where the identifier related to the hardware component is not stored in the storage and/or a version associated with the hardware component or hardware component analysis rules indicates that the stored version is out of date based on a comparison to the stored version information.

Continuing to 201, the processor queries the hardware component for an analysis rule associated with the hardware component. For example, the hardware component may be designed to communicate with the processor and to store analysis rule information. The hardware may include software and/or firmware to retrieve the analysis rules data and transmit it to the rules engine for storage. The processor may request update information related to a specific type of rule and/or request general information related to updated analysis rules. The processor may compare the received information to stored analysis rules associated with the hardware component, and update the storage in cases of missing or changed rules. In one implementation, the processor sends the received rules to a storage to update.

The analysis rules may be any suitable analysis rules related to the hardware component. For example, the analysis rules may be related to a single hardware component, correlations between hardware components, or based on sets of components. The analysis rules may also include information related to a relationship with software or related to software to execute on the hardware component. An analysis rule may include threshold information for when to provide an error information or pattern information related to recognizing an error. The computing system may include hardware and software rules. A single hardware components may have multiple rules and types of rules to send to the storage. In some cases, there may be individual version identifiers for the group of rules or for the individual analysis rules. For example, a CPU may send information about analysis rules related to a cache subcomponent and related to a control unit subcomponent. In one implementation, the query for rules may be related to particular subcomponent of the hardware component.

In one implementation, the processor similarly queries software for analysis rule information and/or the analysis rule received from the hardware component includes some information about software. The analysis rule information may be related to software compatibility with the hardware component. The software related rules may be any suitable rules. The software may have an identifier to identify it in the storage. For example, the identifier may be the application name or a hash from the binary image of the application. The analysis rules and/or application may have a version number. The application data may relate to the workload, such as number of pages loaded or number of queries run. The information could be used by the analysis engine to determine information, such as watts consumed per page loaded.

In one implementation, the processor may attempt to retrieve analysis rules in another manner when analysis rules are not received from the hardware component. For example, the processor may attempt to find analysis rules from the Internet, from a manufacturer website, or other rule engines. In one implementation, the processor causes a user interface to be displayed to request analysis rules from an administrator and/or alert the administrator that analysis rules were not available. The user interface may include information related to the hardware component such that the administrator may be able to identify the particular component, such as the rack and shelf location,

At 202, the processor receives the analysis rules from the hardware component in response to the query. For example, a network request or 120 transaction may be used to request the analysis rules from the hardware component.

Continuing to 203, the processor analyzes the computing system performance based on the received analysis rule associated with the hardware component and a workload to be executed on the computing system. For example, the rules analysis engine may use stored analysis rules updated by the processor to make predictions based on a comparison of analysis rules related to components, such as both hardware and software components, and expected or actual workloads running on the computing system. The rules analysis engine may make suggestions for changes in hardware components or configurations based on the analysis.

In one implementation, the computing system separately stores rules associated with workloads, and the workload rules have identifiers and version numbers associated with them. The workload may be, for example, any program running on the computing system, such as related to software, firmware, or an operating system. The workload rules may be, for example, number of web pages served, number of database lookups, or number of transactions processed. A workload may be separately updated from the analysis rules, and a workload may be selected for a simulation to be compared to the current hardware rules. The analysis rules associated with the workload may be any suitable rules related to the type of processes to be executed on the computing system. The workload rules may be used to recognize unexpected or inefficient behavior in the computing system, and the information may be used to troubleshoot or improve the computing system.

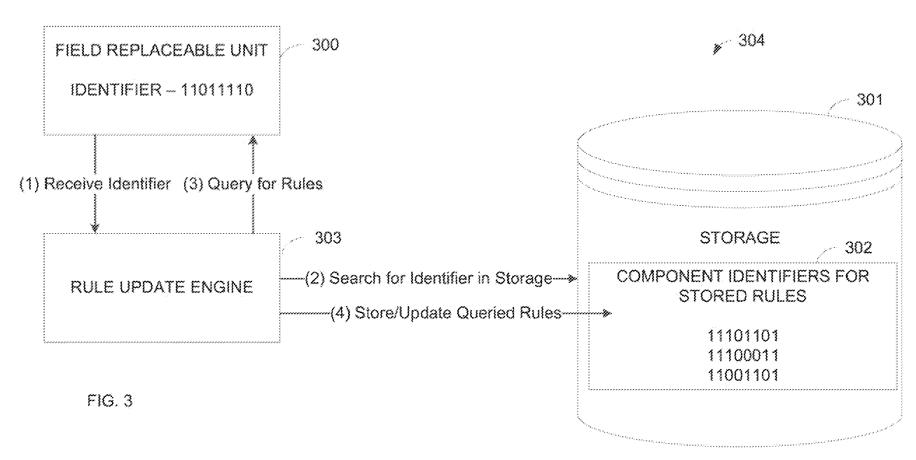

FIG. 3 is a block diagram of a computing system 304 to store analysis rules associated with a hardware component. The computing system 304 includes a field replaceable unit 300, a storage 301, and a rule update engine 303. The field replaceable unit 300 may be any suitable hardware component, such as a fan or power supply. The storage 301 may be any suitable storage to store information related to hardware component analysis rules, such as a local or global storage. Block 302 shows hardware component identifiers stored. In one implementation, the storage 301 also stores version numbers associated with the hardware components analysis rules.

The rules analysis engine 303 may receive identifier and/or version information from the field replaceable unit 300. For example, the rules analysis engine 303 may request the information, or the field replaceable unit 300 may transmit the information at a regular interval and/or in response to initialization or change.

The rules analysis engine 303 may compare the received identifier and/or version information to the information stored in the storage 301. For example, block 302 shows that the identifier of the field replaceable unit 300 is not stored in the storage 301. An identifier or version not stored in the storage 301 may indicate that new analysis rules should be retrieved. The rules update engine 302 may send a request to the field replaceable unit 300 for the updated analysis rules. The field replaceable unit 300 may respond with its current stored analysis rules. The rules analysis engine 303 may store the received rules in the storage 302. In one implementation, the rules analysis engine 303 may analyze information associated with the received analysis rules to determine whether to store them, such as based on whether the received version is the same as or greater than the stored version number.

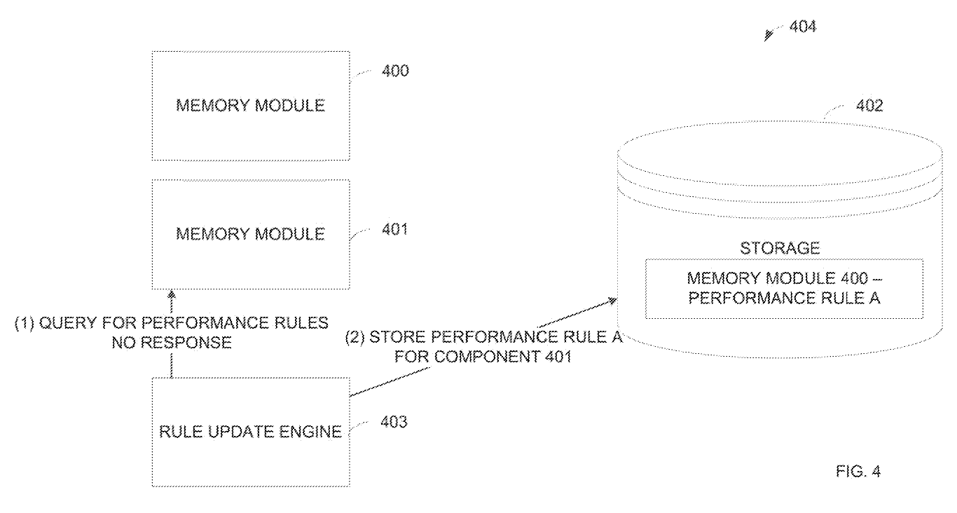

FIG. 4 is a block diagram illustrating one example of a computing system 401 to associate an analysis rule with a hardware component. The computing system 401 includes two hardware components, a memory module 400 and a memory module 401, a storage 402, and a rules update engine 403. The rules update engine 403 may update analysis rules associated with a hardware component based on rules associated with the same type of similar hardware components. For example, a new hardware component may include more up to date analysis rules than a hardware component of the same type included in the computing system at an earlier time.

The rules update engine 403 may not receive a response from the memory module 401 to a query to receive updated analysis rules. For example, the hardware component may not include stored analysis rules or may have a malfunction affecting its ability to communicate the analysis rules information. The rules update engine 403 may query the storage 402 to determine if the storage 402 includes analysis rules that may be associated with the memory module 401. For example, the rules update engine 403 may request information related to analysis rules associated with other memory modules, and store the same memory module rules, such as performance rule A, associated with memory module 400 also with memory module 401. Using analysis rules from other hardware components may increase the likelihood that the analysis rules are up to date without connecting to the Internet due to the fact that hardware components may be installed or updated at different times and include updated analysis rules information.

A rules analysis engine that queries hardware components for analysis rules provides greater accuracy for a computing system analysis engine in cases where an Internet connection is not available or a client prefers that the system not connect to the Internet. The analysis engine may compare the updated analysis rules information to workload information to dynamically provide analysis related to the computing system.

1. A computing system, comprising:
a plurality of hardware components;
a storage to store analysis rules associated with the hardware components;
a rule update module to:
query a first hardware component for analysis rules associated with the hardware component; and
store in the storage rules received from the first hardware component in response to the query;
a system analysis module to analyze the performance of the computing system based on a workload and the stored rules associated with the hardware components; and
a processor to execute the rule update module and the system analysis module.

2. The computing system of claim 1, wherein the rule update engine is further to:
query a computing device to determine analysis rules associated with the first hardware component, and
wherein the rule update engine queries the first hardware component when analysis rules are not received in response to the query to the computing device.

3. The computing system of claim 1, wherein the rule update engine requests user input to provide analysis rules for the first hardware component if the query does not return analysis rules.

4. The computing system of claim 1, wherein the rule update engine is further to:
identify a second hardware component as a similar type as the first hardware component; and associate the stored rules of the first hardware component with the second hardware component.

5. The computing system of claim 1, wherein the analysis rules include information about a related component in the system.

6. The computing system of claim 1, wherein the rule update engine is further to query the storage for rules associated with the first hardware component and to query the hardware component based on the response from the storage.

7. A method, comprising:
determining, by a processor, to retrieve analysis rules associated with a first hardware component within a computing system;
querying the hardware component for analysis rules associated with the hardware component; and
analyzing the computing system based on the received analysis rules associated with the first hardware component and a workload to be executed on the computing system.

8. The method of claim 7, further comprising:
determining to retrieve an analysis rule associated with a second hardware component;
determining a similarity between the second hardware component and the first hardware component; and
associating the analysis rule of the first hardware component with the second hardware component.

9. A computer readable non-transitory storage medium comprising instructions executable by a processor to:
determine analysis rules to associate with components of a computer system,
wherein instructions to determine analysis rules comprise instructions to determine an analysis rule associated with a hardware component by querying the hardware component;
perform system analytics based on the analysis rules associated with the components and analysis rules associated with a workload.

10. The machine-readable non-transitory storage medium of claim 9, further comprising instructions to apply an analysis rule of a first component to a second component where the first component and the second component are determined to be of similar types.

11. The machine-readable non-transitory storage medium of claim 9, further comprising instructions to determine analysis rules where a performance rule for a component is not stored in a storage.

12. The machine-readable non-transitory storage medium of claim 11, wherein determining that a performance rule for a component is not stored in a storage comprises instructions to query the storage based on an identifier associated with the component.

13. The machine-readable non-transitory storage medium of claim 12, wherein an identifier related to a software application component is related to a binary hash of the application.

14. The machine-readable non-transitory storage medium of claim 9, wherein instructions to determine analysis rules comprise instructions to determine a rule associated with a software application by querying the software application.

15. The machine-readable non-transitory storage medium of claim 9, wherein an analysis rules associated with a software application includes a rule related to hardware compatibility information for the software application.
